(19) United States
(12) Patent Application Publication
(10) Pub. No.: US 2017/0284102 A1
(43) Pub. Date: Oct. 5, 2017

(54) GREEN ROOFING SUBSTRATE BRICK AND METHOD OF INSTALLING SAME

(71) Applicant: University of Guelph, Guelph (CA)

(72) Inventors: Greg Yuristy, Guelph (CA); Youbin Zheng, Puslinch (CA)

(73) Assignee: University of Guelph, Guelph, ON (CA)

(21) Appl. No.: 15/508,171

(22) PCT Filed: Sep. 8, 2015
(86) PCT No.: PCT/CA2015/050866

§ 371 Date: Mar. 2, 2017

Related U.S. Application Data
(60) Provisional application No. 62/047,184, filed on Sep. 8, 2014.

(51) Int. Cl. E04D 11/00; D06N 5/00; A01G 1/00

(52) U.S. Cl. CPC E04D 11/002; A01G 1/007; D06N 5/00

(57) ABSTRACT

A green roofing substrate brick comprises a water-permeable fabric box having an open top, and a solidified and non-compressed substrate in the box. The substrate comprises a water storage and drainage medium, and a binder solidifying the water storage and drainage medium.

### CROSS REFERENCES TO RELATED APPLICATIONS

This application claims the benefit of U.S. provisional patent application Ser. No. 62/047,184, filed on Sep. 8, 2014, which is incorporated herein by reference in its entirety.

### FIELD

The disclosure relates to green roofing, and to substrates that may be used in green roofing. More specifically, the disclosure relates to such substrates that are in brick form, and to methods for making and installing substrate bricks.

### BACKGROUND

Chinese Utility Model Patent No. CN 2805332Y (Chengcheng) purports to disclose a substrate brick packed with a non-woven fabric. The substrate brick includes a brick-shaped substrate block, which is wrapped with the non-woven fabric. The brick can be laid on a roof

German Patent Application No. DE 202005009722U1 (Holtvogt et al.) purports to disclose a substrate block for a green roof on a building. The substrate block has a bottom layer of felt, with a thick substrate layer in which plant roots can grow and pick up nutrients.

### SUMMARY

The following summary is intended to introduce the reader to various aspects of the disclosure, but not to define any invention.

According to one aspect, a green roofing substrate brick is provided. The green roofing substrate brick comprises a water-permeable box having an open top. A solidified and non-compressed substrate is in the box. The substrate comprises a water storage and drainage medium, and a binder solidifying the water storage and drainage medium.

In some examples, the water storage and drainage medium comprises a mixture of an aggregate water storage medium, an organic water storage medium, and a drainage medium. In some examples, the aggregate water storage medium comprises aggregates of expanded slate and/or clay. In some examples, the organic water storage medium comprises at least one of composted pine and anaerobic digester waste, or peat moss. In some examples, the drainage medium comprises polystyrene. In some examples, the binder comprises a polysaccharide, for example guar gum.

In some examples, the water storage and drainage medium comprises between about 60 vol. % and 70 vol. % aggregate water storage medium, between about 25 vol. % and about 35 vol. % organic water storage medium, and up to about 10 vol. % drainage medium.

In some examples, the substrate is dry.

In some examples, the water permeable box comprises a geotextile. In some examples, the geotextile is a non-woven punched geotextile. In some examples, the geotextile is hydrophilic. In other examples, the geotextile is woven.

In some examples, the substrate is non-pre-vegetated.

In some examples, the green roofing substrate brick further comprises a drainage layer secured to a bottom wall of the water-permeable box. In some examples, the drainage layer comprises a water permeable dimpled membrane. In some examples, the dimpled membrane is perforated to provide water permeability. In some examples, the dimpled membrane comprises a generally planar upper surface secured to the bottom wall, and a plurality of dimples extending downwardly from the upper surface.

In some examples, the box has a box footprint, and the drainage layer has a drainage layer footprint that is larger than the box footprint. This defines on the drainage layer a central portion secured to the bottom wall of the box, and a lap portion extending beyond the bottom wall of the box. In some examples, the dimples of the central portion are configured to nest within the dimples of the lap portion of an adjacent green roofing substrate brick, to connect the green roofing substrate brick to the adjacent green roofing substrate brick.

In some examples, the green roofing substrate brick further comprises a fastener extending through at least one of the dimples of the lap portion, for securing the green roofing substrate brick to the adjacent green roofing substrate brick.

In some examples, the green roofing substrate brick further comprises a water retaining layer in the box beneath the substrate.

According to another aspect, a method for making a green roofing substrate brick is disclosed. The method comprises a) filling a water-permeable box with a water storage and drainage medium, and b) solidifying the water storage and drainage medium with a binder.

In some examples, prior to step a), the method comprises combining the water storage and drainage medium with the binder. In some examples, combining the water storage and drainage medium with a binder comprises moistening the water storage and drainage medium, and adding the binder in a powdered form to the moistened water storage and drainage medium. In alternative examples, combining the water storage and drainage medium with a binder comprises adding the binder in aqueous form to the water storage and drainage medium

In some examples, the water storage and drainage medium comprises a mixture of an aggregate water storage medium, an organic water storage medium, and a drainage medium. In some examples, the binder comprises a polysaccharide, such as guar gum.

In some examples, the method further comprises drying the water storage and drainage medium.

According to another aspect, a green roofing substrate brick is provided. The green roofing substrate brick comprises a water-permeable box, and a substrate in the box. The substrate comprises an aggregate water storage medium, an organic water storage medium, a drainage medium, and a binder binding the aggregate water storage medium, organic water storage medium, and drainage medium.

In some examples, the aggregate water storage medium comprises aggregates of expanded slate, shale, or clay, or mixtures thereof. In some examples, the organic water storage medium comprises at least one of composted pine and anaerobic digester waste or peat moss. In some examples, the drainage medium comprises polystyrene. In some examples, the binder comprises a polysaccharide, for example guar gum.

In some examples, the water storage and drainage medium comprises between about 60 vol. % and 70 vol. % aggregate water storage medium, between about 25 vol. % and about 35 vol. % organic water storage medium, and up to about 10 vol. % drainage medium.

In some examples, the substrate is dry.

According to another aspect, a green roofing substrate brick is provided. The green roofing substrate brick comprises a water-permeable box having a bottom wall and an open top opposed to the bottom wall. A substrate is in the box. The substrate comprises a water storage and drainage medium. A drainage layer is secured to the bottom wall. The drainage layer comprises a water permeable dimpled membrane.

In some examples, the dimpled membrane comprises a generally planar upper surface secured to the bottom wall, and a plurality of dimples extending downwardly from the upper surface.

In some examples, the dimpled membrane is perforated to provide water permeability.

In some examples, the box has a box footprint, and the drainage layer has a drainage layer footprint that is larger than the box footprint. This defines on the drainage layer a central portion secured to the bottom wall of the box, and a lap portion extending beyond the bottom wall of the box. In some examples, the dimples of the central portion are configured to nest within the dimples of the lap portion of an adjacent green roofing substrate brick, to connect the green roofing substrate rick to the adjacent green roofing substrate brick.

In some examples, the green roofing substrate brick further comprises a fastener extending through at least one of the dimples of the lap portion, for securing the green roofing substrate brick to the adjacent green roofing substrate brick.

According to another aspect, a green roofing substrate brick is provided. The green roofing substrate brick comprises a water-permeable box having a bottom wall and an open top opposed to the bottom wall. A substrate is in the box. The substrate comprises a water storage and drainage medium. A connector is secured to the box for connecting the box of the green roofing substrate brick to a box of an adjacent green roofing substrate brick.

In some examples, the box of the green roofing substrate brick comprises a bottom wall, and the connector comprises a dimpled membrane secured to the bottom wall. In some examples, the dimpled membrane comprises dimples that are nestable within dimples of the adjacent green roofing substrate brick, to connect the green roofing substrate brick to the adjacent green roofing substrate brick.

In some examples, the box has a box footprint, and the dimpled membrane has a dimpled membrane footprint that is larger than the box footprint. This defines on the dimpled membrane a central portion secured to the bottom wall of the box, and a lap portion extending beyond the bottom wall of the box. In some examples, the dimples of the central portion of the green roofing substrate brick are configured to nest within the dimples of the lap portion of the adjacent green roofing substrate brick.

In some examples, the central portion further comprises a fastener extending through at least one dimple of the lap portion, for securing the green roofing substrate brick to the adjacent green roofing substrate brick. The connector comprises a rivet extending through the at least one dimple, and receivable in one of the dimples of the adjacent green roofing substrate brick.

In some examples, the green roofing substrate brick further comprises a water retaining layer in the box beneath the substrate.

According to another aspect, a kit of parts for a green roofing installation is provided. The kit of parts comprises a plurality of green roofing substrate bricks, wherein the green roofing substrate bricks are non-prevegetated. The kit of parts further comprises a pre-vegetated mat for laying over the green roofing substrate bricks.

According to another aspect, a method for installing a green roof is provided. The method comprises laying a plurality of green roofing substrate bricks on a roof, wherein the green roofing substrate bricks are non-prevegetated. The method further comprises laying a pre-vegetated mat over the green roofing substrate bricks

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a perspective view of an example green roofing substrate brick;

FIG. 2 is a top plan view of the green roofing substrate brick of FIG. 1;

FIG. 3A is a cross-section taken along line 3A-3A in FIG. 2;

FIG. 3B is a cross-section taken along line 3B-3B in FIG. 2;

FIG. 4A is a side elevation view of the green roofing substrate brick of FIG. 1, connected to an adjacent green roofing substrate brick;

FIG. 4B is a partial perspective exploded view of the green roofing substrate brick and adjacent green roofing substrate brick of FIG. 4A

FIG. 5 is a vertical cross-section taken through the green roofing substrate brick and adjacent green roofing substrate brick of FIG. 4;

FIG. 6 is a perspective view of an alternative green roofing substrate brick that is installable on a ridge of a roof;

FIG. 7 is a side elevation view of the ridge brick of FIG. 6 installed on a roof ridge; and

FIG. 8 is a vertical cross-section taken through an alternative green roofing substrate brick.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any exclusive right granted by issuance of this patent application. Any invention disclosed in an apparatus or process described below and for which an exclusive right is not granted by issuance of this patent application may be the subject matter of another protective instrument, for example, a continuing patent application, and the applicants, inventors or owners do not intend to abandon, disclaim or dedicate to the public any such invention by its disclosure in this document.

The disclosure relates to green roofing substrate bricks (also referred to herein as “bricks”). In some examples, the bricks are used in any suitable green roofing installation, for example on the roof of a residential, commercial, or industrial building. In some examples, the bricks generally serve the purpose of water storage and drainage for a vegetation layer installed thereon. The bricks are in some examples generally dry and lightweight, allowing for ease of installation. The bricks in some examples are essentially completely dry. The bricks are in some examples non-prevegetated, which in some examples allow for the bricks to be pre-fabricated and readily handled, stored and/or stacked.

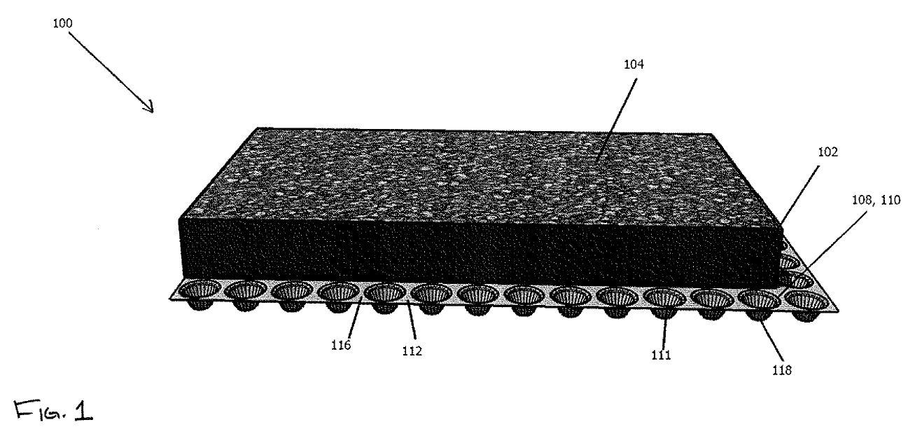

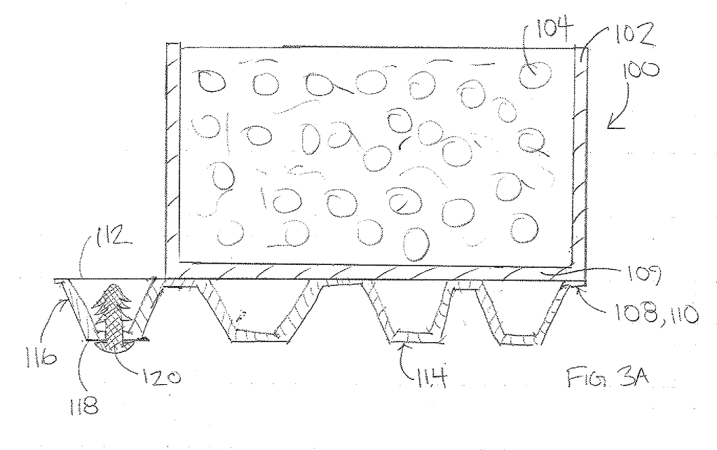

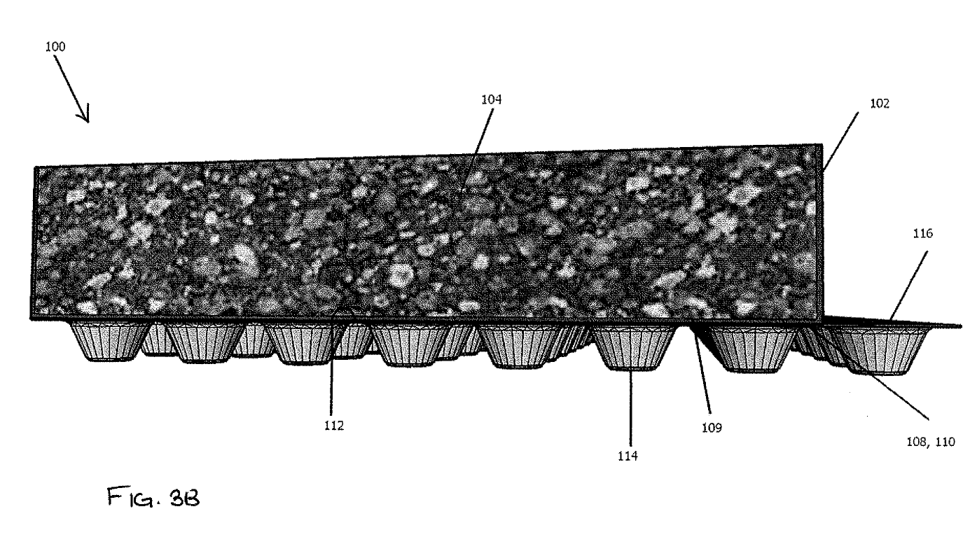

Referring now to FIGS. 1 to 3, an example brick 100 is shown. The brick 100 generally includes a box 102 that has an open top, and a substrate 104 in the box 102. In some examples, the substrate 104 partially fills the box. In some examples, the substrate 104 fully fills the box 102. In the example shown, the brick 100 further includes a drainage layer 108 secured to a bottom wall 109 of the box 102.

In the example shown in FIGS. 1 to 3, the box 102 is generally cubic. In some examples, the box is provided in various sizes, such as, but not limited to, 30 cm by 30 cm, 60 cm by 60 cm, or 30 cm by 60 cm (length by width). The height of the box is in some examples between 5 cm and 20 cm.

In alternative examples, the box is of another shape.

In the example shown in FIGS. 1 to 3, the box 102 is generally water permeable, to allow for drainage. In some particular examples, the box 102 is fabricated from a non-woven needle-punched geotextile. In some particular examples, the geotextile is hydrophilic, which in some examples allows for improved water storage. The geotextile in some examples has a weight ranging from about 200 g/m² to 600 g/m².

In alternative examples, the box is of another material, such as a woven geotextile.

In some examples, the box allows for roots to grow therethrough.

Referring still to FIGS. 1 to 3, the drainage layer 108 is secured to the bottom wall 109 of the box 102. In some examples, the drainage layer 108 serves to space the box 102 away from the roof on which the brick 100 is installed, while allowing for water to drain therethrough and flow between the roof and the box 102.

In the example shown, the drainage layer 108 includes a dimpled membrane 110 that is water permeable. In some examples, the drainage layer 108 includes perforations (not shown) to provide water permeability.

The dimpled membrane 110 has a generally planar upper surface 112 that is secured to the bottom wall 109 of the box 102, and a plurality of dimples 111 that extend downwardly from the upper surface 112, and are open at the upper surface 112.

In some examples, the dimpled membrane 110 is fabricated from a plastic, for example from HDPE plastic. In some examples, the dimpled membrane 110 is spot-welded to the box 102.

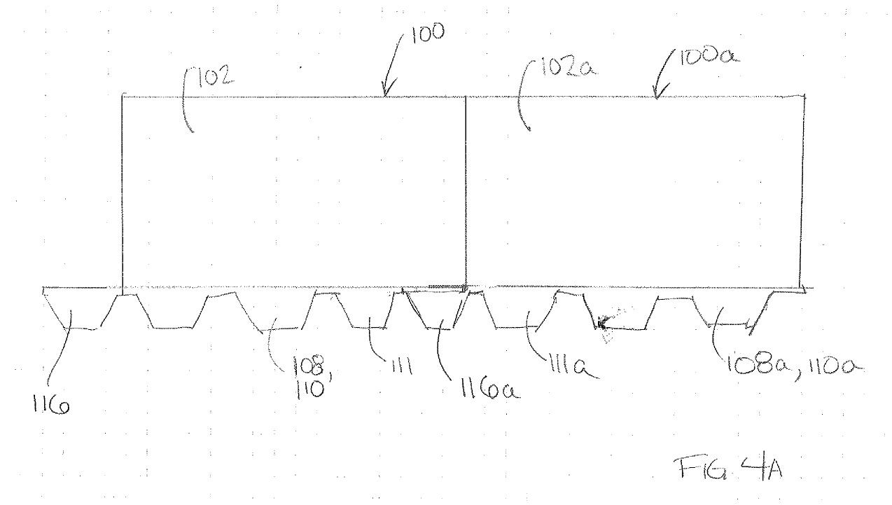

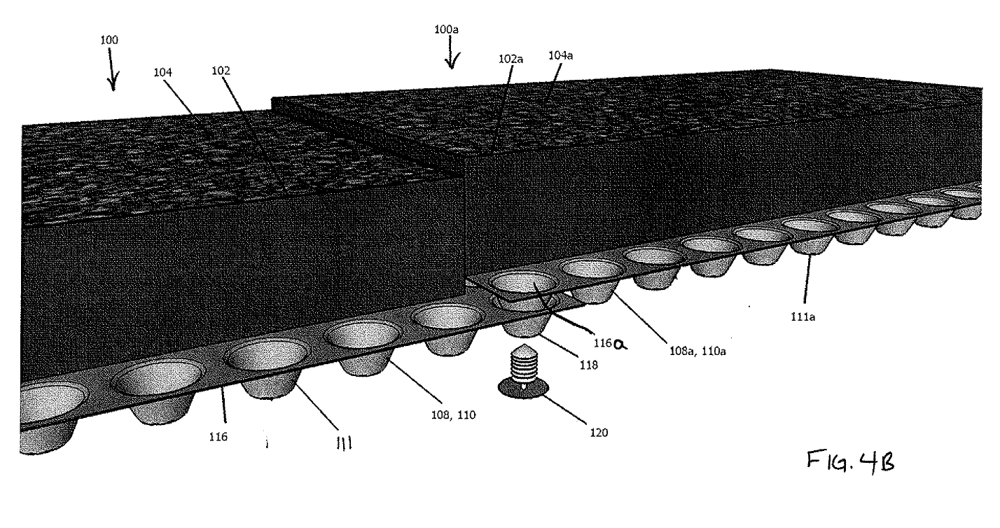

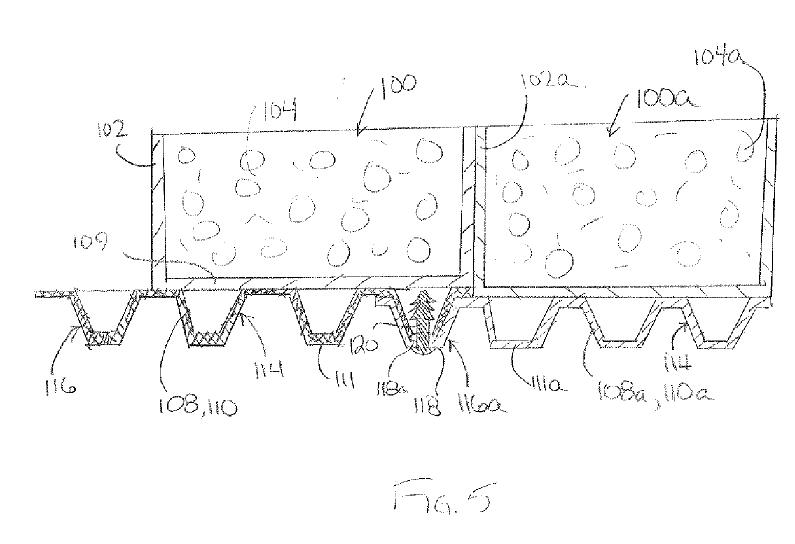

Referring to FIGS. 4 and 5, in the example shown, the drainage layer 108 also serves as a connector for connecting the brick 100 to an adjacent brick 100a. In FIGS. 4 and 5, the adjacent brick 100a is labeled with like numerals as the brick 100, with the suffix “a” added to the reference numerals.

In the example shown, the drainage layer 108 has a footprint (also referred to as a drainage layer footprint) that is larger than the footprint of the box 102 (also referred to as a box footprint), so that the drainage layer 108 has a central portion 114 secured to the bottom wall 109 of the box 102, and a lap portion 116 extending beyond the bottom wall 109 of the box 102. The dimples 111 of the central portion 114 are configured to nest within the dimples 111a of the lap portion 116a of the adjacent brick 100a, to connect the brick 100 to the adjacent brick 100a.

In some examples, an additional fastener is provided for further securing the brick 100 to the adjacent brick 100a. In some examples, one or more dimples 111 of the lap portion 116 includes an aperture through the base 118 thereof and a rivet 120 is positionable in the aperture. The rivet 120 is in some examples a pine tree rivet. In some examples, the rivet 120 is receivable in one of the dimples 111a of the adjacent brick 102a. In the example shown, in the adjacent brick 100a, one or more dimples 111a of the central portion 114a includes an aperture through the base 118a thereof. When the dimples 111a of the central portion 114a are nested into the dimples 111 of the lap portion 116, the dimples 111a of the central portion 114a are pressed downwardly to force the rivet 120 through the aperture in the base 118a, and secure the adjacent brick 100a to the brick 100.

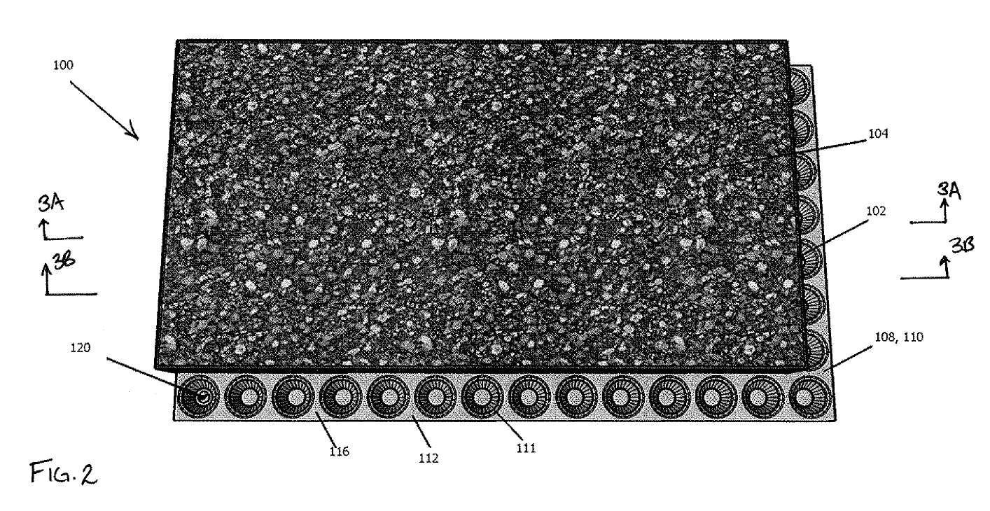

Referring back to FIG. 2, in the example shown, the lap portion 116 extends along two of the four sides of the brick 100, so that the lap portion 116 of each brick 100 in an installation can connect to the respective central portions of two adjacent bricks, and so that central portion 114 of each brick 100 can connect to the respective lap portions of two adjacent bricks.

In alternative examples, the lap portion 116 extends along only one side of the brick 100. In further alternative examples, the lap portion 116 extends along more than two sides of the brick 100.

Referring again to FIGS. 1 to 3, in the example shown, the substrate 104 generally serves the purpose of water storage, while allowing for drainage therethrough.

In some examples, the substrate 104 is generally solidified, but non-compressed. For example, the substrate 104 is leveled and settled within the box 102, but significant pressure is not applied to compress the substrate 104. Furthermore, in some examples, prior to being installed on a roof, and during installation on the roof, the substrate 104 is generally dry. This in some examples allows for ease of transport, storage, and/or installation, as the brick in some such examples is generally lightweight.

In some examples, the substrate 104 includes a water storage and drainage medium, and a binder solidifying the water storage and drainage medium. In some examples, the water storage and drainage medium includes a mixture of an aggregate water storage medium, an organic water storage medium, and a drainage medium.

In some examples, the aggregate water storage medium includes, but is not limited to, expanded clay aggregates, expanded slate, expanded shale, expanded glass, or pumice, or mixtures thereof. In one particular example the aggregate water storage medium consists of clay aggregates produced by Big River Industries (Georgia, U.S.A.) under the brand name Hydrocks®.

In some examples, the organic water storage medium includes, but is not limited to, composted pine, dry waste from an anaerobic digester, peat moss, organic and non-organic compost, and mixtures thereof.

In some examples, the drainage medium includes, but is not limited to, polystyrene such as crushed recycled polystyrene, sand, and surface. In some examples, the drainage medium also serves to store some water.

In some examples, the water storage and drainage medium includes between about 60 vol. % and 70 vol. % aggregate water storage medium, between about 25 vol. % and about 35 vol. % organic water storage medium, and up to about 10 vol. % drainage medium. In one particular example, the water storage and drainage medium includes about 65 vol. % Hydrocks®, about 30 vol. % crushed recycled polystyrene, and about 5 vol. % composted pine.

In some examples, the binder includes a polysaccharide. Examples of polysaccharides include, but are not limited to, natural polysaccharides such as guar gum, flour, corn starch, potato starch, and plantago starch and mixtures thereof, or synthetic polysaccharides such as those sold by Rantec Corporation (Wyoming, U.S.A.) under the brand name Oriox 255™, including Oriox A and Oriox D. In other examples, the binder is another type of polymer, such as a polyacrylamide.

In some examples, additives are used to enhance the binding properties of the binder. Examples of additives include sodium borate. In some examples, heat is also used to enhance the binding properties of the binder.

In general, in some examples, in order to make the brick, the drainage layer 108 is first secured to the box 102, for example by spot welding. The box 102 is then be filled with the water storage and drainage medium, and the water storage and drainage medium is solidified with the binder.

In alternative examples, the drainage layer 108 is secured to the box 102 after the box is filled.

In some examples, the water storage and drainage medium is combined with the binder prior to filling the box 102 with the water storage and drainage medium. After combining the water storage and drainage medium with the binder, the water storage and drainage medium is added to the box 102, and the binder is allowed to set to bind the water storage and drainage medium and yield a solidified substrate.

In some particular examples, in order to combine the water storage and drainage medium and the binder, the water storage and drainage medium is first moistened. In some examples, between about 10 vol. % and 25 vol. % water is added and mixed into the water storage and drainage medium. The binder, optionally in powder form, is then combined with the moistened water storage and drainage medium. In some examples between about 0.25 vol. % and about 4 vol. % binder is added. In some particular examples, between about 0.75 vol. % and about 1 vol. % binder is added. It has been determined that this method may work particularly well when using relatively strong binders such as guar gum.

In other examples, in order to combine the water storage and drainage medium, the binder is added in aqueous form to the water storage and drainage medium. For example, the binder is added to a volume of water, and the mixture is then heated, for example is boiled. The resulting solution is then added to the water storage and drainage medium. It has been determined that this method may work particularly well when using weak binders such as flour, corn starch, and potato starch.

In some examples, after combining the water storage and drainage medium and binder, the mixture is allowed to sit for a period of time. For example, the mixture is allowed to sit for between about 30 minutes and about 90 minutes, more specifically for between about 45 minutes and about 60 minutes.

In some examples, after allowing the mixture to sit, the mixture is added to the box 102, and allowed to set.

In some examples, as mentioned above, the substrate 104 is non-compressed. That is, after adding the water storage and drainage medium and binder to the box 102, they are allowed to set and solidify without a step of compressing the substrate. For example, the substrate is leveled, and the box is agitated to settle the substrate, but significant pressure is not applied to compress the substrate.

In some examples, after the substrate is set, the brick 100 is dried. For example, the brick 100 is dried by heating the brick under constant airflow.

As mentioned above, in some examples, the brick 100 is non-prevegetated. That is, the brick 100 is in some examples manufactured and installed without the inclusion of seeds, seedlings, plants, or any other vegetation. In some examples, subsequent to installation of the bricks 100 on a roof, as will be described in further detail below, the vegetation is applied to the bricks 100.

In some examples, in order to install the bricks 100 on a roof, the bricks 100 are laid on the roof and connected together. For example, the bricks 100 are laid down, and connected together by nesting the dimples 111 of each brick 100 within the dimples of an adjacent brick, as described above. The bricks are optionally secured together with a fastener, such as one or more rivets 120 as described above.

In some examples, a waterproofing layer is laid on the roof prior to laying the bricks 100 on the roof.

In some examples, the bricks 100 are installed in a staggered fashion, similarly to standard masonry bricks, so that they are not arranged in regular rows and columns.

In some examples, after the bricks 100 are installed, vegetation is applied to the bricks 100. For example, a pre-vegetated mat is installed on top of the bricks. One suitable pre-vegetated mat is described in PCT Publication No. WO/2014/117276 (application No. PCT/CA2014/050064), entitled SOILLESS PRE-VEGETATED MAT AND PROCESS FOR PRODUCTION THEREOF, which is incorporated herein by reference in its entirety.

In other examples, vegetation is applied to the bricks in a different fashion. In some examples, hydroseeding is used to apply vegetation to the bricks. In some examples, cuttings are layed over the bricks and temporarily secured with hydroseeding mulch. In some examples, plug plants are planted.

In some examples, as vegetation grows on the bricks, the roots of the vegetation penetrate the box of each brick, and grow in to adjacent boxes. In some examples, this further secures the bricks together.

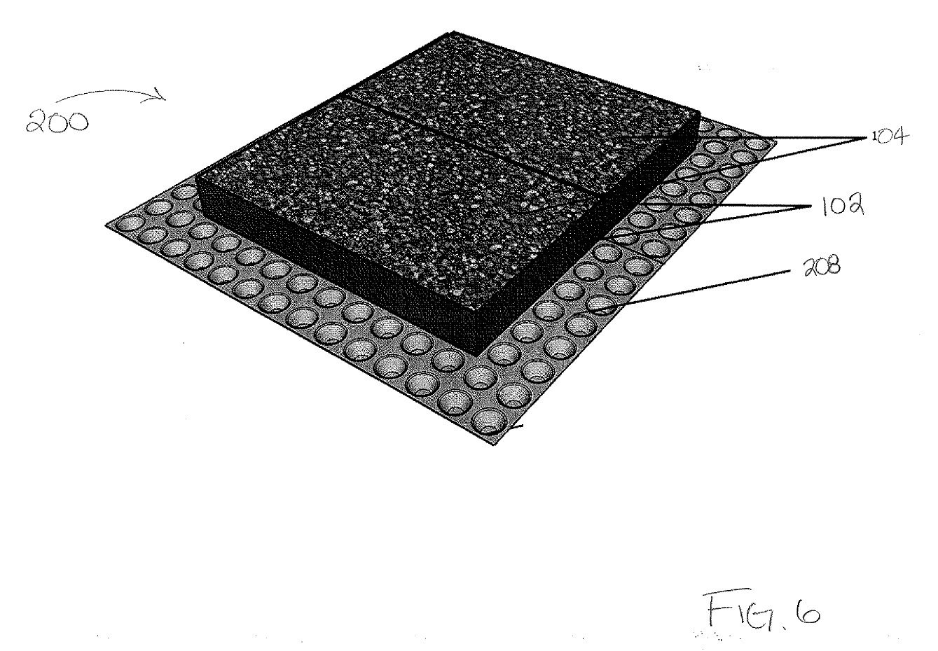

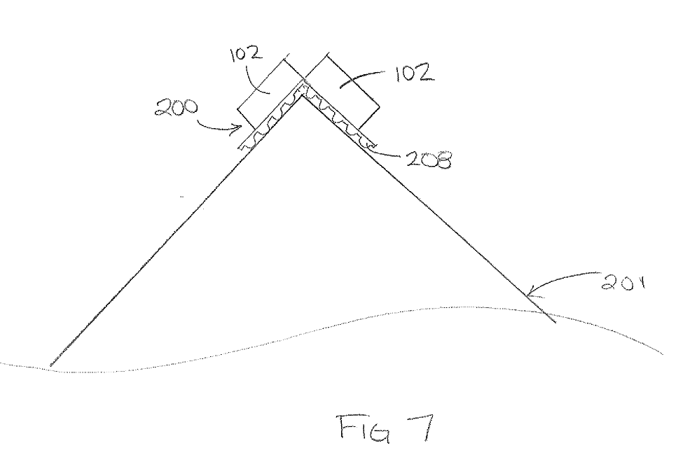

Referring now to FIG. 6, a ridge brick 200 is shown. The ridge brick 200 is for installing on a ridge of a roof 201, as shown in FIG. 7, and is configured to flex in the middle thereof, to accommodate ridges of various angles.

In the example shown, the ridge brick 200 includes two separate boxes 102, which are positioned adjacent each other, and each of which contains substrate 104. The boxes are secured to a common drainage layer 208.

In use, in some examples, the ridge brick 200 is installed on the ridge of a roof so that each box 102 is on an opposite side of the ridge, and so that the drainage layer 208 flexes in the middle.

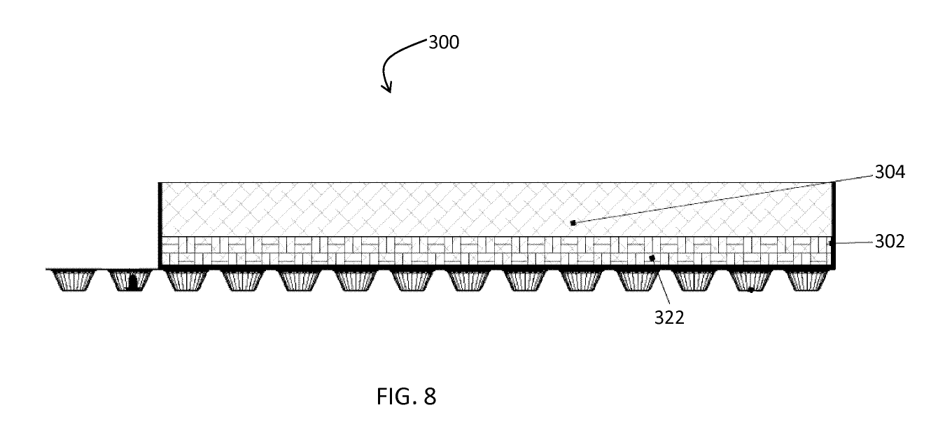

Referring now to FIG. 8, an alternative brick 300 is shown. In FIG. 8, like features as in FIGS. 1 to 5 are shown with like reference numerals, incremented by 200. The brick 300 includes a water retaining layer 322 inside the box 302, beneath the substrate 304. The water retaining layer 322 is in some examples a fabric, such horticultural rockwool or other mineral fibre fabric. In some examples, the use of water retaining layer 322 allows for the brick 300 to be relatively lightweight, while still retaining significant amounts of water.

While the above description provides examples of one or more processes or apparatuses, it will be appreciated that other processes or apparatuses may be within the scope of the accompanying claims.

1. A green roofing substrate brick comprising:
a) a water-permeable box having an open top; and
b) a solidified and non-compressed substrate in the box, the substrate comprising a water storage and drainage medium, and a binder solidifying the water storage and drainage medium.

2. The green roofing substrate brick of claim 1, wherein the water storage and drainage medium comprises a mixture of an aggregate water storage medium, an organic water storage medium, and a drainage medium.

3.-7. (canceled)

8. The green roofing substrate brick of claim 2, wherein the water storage and drainage medium comprises between about 60 vol. % and 70 vol. % aggregate water storage medium, between about 25 vol. % and about 35 vol. % organic water storage medium, and up to about 10 vol. % drainage medium.

9.-12. (canceled)

13. The green roofing substrate brick of claim 1, wherein the substrate is non-pre-vegetated.

14. The green roofing substrate brick of claim 1, further comprising a drainage layer secured to a bottom wall of the water-permeable box.

15. The green roofing substrate brick of claim 14, wherein the drainage layer comprises a water permeable dimpled membrane.

16. The green roofing substrate brick of claim 15, wherein the dimpled membrane is perforated to provide water permeability.

17. The green roofing substrate brick of claim 15, wherein the dimpled membrane comprises a generally planar upper surface secured to the bottom wall, and a plurality of dimples extending downwardly from the upper surface.

18. The green roofing substrate brick of claim 14, wherein the box has a box footprint, and the drainage layer has a drainage layer footprint that is larger than the box footprint, to define on the drainage layer a central portion secured to the bottom wall of the box, and a lap portion extending beyond the bottom wall of the box.

19. The green roofing substrate brick of claim 18, wherein the dimples of the central portion are configured to nest within the dimples of the lap portion of an adjacent green roofing substrate brick, to connect the green roofing substrate brick to the adjacent green roofing substrate brick.

20. The green roofing substrate brick of claim 19, further comprising a fastener extending through at least one of the dimples of the lap portion, for securing the green roofing substrate brick to the adjacent green roofing substrate brick.

21. The green roofing substrate brick of claim 1, further comprising a water retaining layer inside the box beneath the substrate.

22. A method for making a green roofing substrate brick, the method comprising:
a) filling a water-permeable box with a water storage and drainage medium; and
b) solidifying the water storage and drainage medium with a binder.

23. The method of claim 22, wherein prior to step a) the method comprises combining the water storage and drainage medium with the binder.

24. The method of claim 23, wherein combining the water storage and drainage medium with a binder comprises moistening the water storage and drainage medium, and adding the binder in a powdered form to the moistened water storage and drainage medium.

25. The method of claim 23, wherein combining the water storage and drainage medium with a binder comprises adding the binder in aqueous form to the water storage and drainage medium.

26. The method of any claim 22, wherein the water storage and drainage medium comprises a mixture of an aggregate water storage medium, an organic water storage medium, and a drainage medium.

27.-29. (canceled)

30. A green roofing substrate brick comprising:
a) a water-permeable box; and
b) a substrate in the box, the substrate comprising
i) an aggregate water storage medium;
ii) an organic water storage medium;
iii) a drainage medium; and
iv) a binder binding the aggregate water storage medium,
organic water storage medium, and drainage medium.

31.-37. (canceled)

38. A green roofing substrate brick comprising:
a) a water-permeable box having a bottom wall and an open top opposed to the bottom wall;
b) a substrate in the box, the substrate comprising a water storage and drainage medium; and
c) a drainage layer secured to the bottom wall, the drainage layer comprising a water permeable dimpled membrane.

39.-44. (canceled)

45. A green roofing substrate brick comprising:
a) a water-permeable box having a bottom wall and an open top opposed to the bottom wall;
b) a substrate in the box, the substrate comprising a water storage and drainage medium; and
c) a connector secured to the box for connecting the box of the green roofing substrate brick to a box of an adjacent green roofing substrate brick.

46.-50. (canceled)

51. A kit of parts for a green roofing installation, the kit of parts comprising:
a) a plurality of the green roofing substrate bricks of claim 1 wherein the green roofing substrate bricks are non-prevegetated; and
b) a pre-vegetated mat for laying over the green roofing substrate bricks.

52. A method for installing a green roof comprising:
a) laying a plurality of the green roofing substrate bricks of claim 1 on a roof, wherein the green roofing substrate bricks are non-prevegetated; and
b) laying a pre-vegetated mat over the green roofing substrate bricks.
